(19) United States
(12) Patent Application Publication
(10) Pub. No.: US 2022/0242547 A1
(43) Pub. Date: Aug. 4, 2022

(54) EXTERNAL AIR BLADDERS

(71) Applicant: Loon LLC, Mountain View, CA (US)

(72) Inventor: Paul Frey, Portola, CA (US)

(21) Appl. No.: 17/162,271

(22) Filed: Jan. 29, 2021

(51) Int. Cl. B64B 1/62; B64B 1/02; B64B 1/40

(52) U.S. Cl. CPC B64B 1/62; B64B 1/40; B64B 1/02

(57) ABSTRACT

Aspects of the technology relate to lighter-than-air (LTA) high altitude platforms configured to operate in the stratosphere. Such platforms can generate solar power from solar panels, enabling long-term operation for weeks, months or longer. Shaped envelope LTA platforms may have solar panels arranged along an upper section of the envelope, which can be particularly helpful when the envelope is made of a fabric that is not transparent or translucent. To address possible thermal effects, aerodynamics and other issues with the solar panels, one or more external air bladders are disposed between the such components and the shaped envelope. One or more perimeter chamber of the air bladder configuration can be employed to create more aerodynamically efficient leading and trailing edges to blend the envelope surface with the surface(s) of the solar panel components. The insulative air bladder(s) may also provide structural support during fill of a shaped envelope at launch.

### BACKGROUND

Telecommunications connectivity via the Internet, cellular data networks and other systems is available in many parts of the world. However, there are locations where such connectivity is unavailable, unreliable or subject to outages from natural disasters. Some systems may provide network access to remote locations or to locations with limited networking infrastructure via satellites or high altitude platforms. In the latter case, due to environmental conditions and other limitations, it is challenging to keep the platforms aloft and operational over a desired service area for long durations, such as weeks, months or longer. Such operation may require platforms capable of generating solar energy for use during the lifespan of the platform. However, employing solar panels or other photovoltaic (PV) components on the platform may affect the overall thermal load, aerodynamic properties, weight balancing, and other aspects of the platform.

### SUMMARY

Aspects of the technology relate to a high altitude platform (HAP) that is able to remain on station or move in a particular direction toward a desired location, for instance to provide telecommunication services, video streaming or other services. The high altitude platform may be a lighter-than-air (LTA) platform such as a balloon, dirigible/airship or other LTA platform configured to operate in the stratosphere. For instance, the LTA platform may include an envelope filled with lift gas and a payload for providing telecommunication or video services, with a connection member coupling the payload with the envelope. The envelope may be a superpressure envelope, e.g., with a ballonet that can be used to aid in altitude control as part of an altitude control system. The payload may be configured to rotate relative to the envelope, such as to improve communication coverage in an area of interest. A lateral propulsion system may provide directional thrust for moving the LTA platform toward a destination or remaining on station over a location of interest (e.g., a city or regional service area). This can include a pointing mechanism that aligns a propeller assembly of the lateral propulsion system along a certain heading.

In order to accommodate larger and more robust LTA platforms that can stay aloft and operational for weeks, months or years at a time, solar panels or other PV components are employed to power various components of the HAP. In certain configurations, such PV components may be arranged along an upper part of a shaped envelope. To address possible thermal effects (e.g., causing increased heating of the gas(es) within the envelope and the envelope itself, which could adversely affect the envelope material), aerodynamics and other issues, one or more external air bladders are disposed between the PV components and the shaped envelope. In some situations, a perimeter chamber (or chambers) can be employed to create more aerodynamically efficient leading and trailing edges to better blend the envelope surface with the surface of the PV components.

According to one aspect, a lighter-than-air (LTA) high altitude platform (HAP) is configured for operation in the stratosphere. The LTA HAP comprises an envelope configured to maintain pressurized lift gas therein, a solar power generation system, an air bladder, and a control system. The solar power generation system includes one or more photovoltaic (PV) components configured to convert light into electricity. The one or more PV components are disposed along a first region of the envelope arranged to face the sun when operating in the stratosphere. The air bladder is disposed between the one or more PV components and the first region of the envelope. The air bladder is configured to provide thermal separation between the one or more PV components and the first region of the envelope. And the control system is configured to cause ambient air to flow into the air bladder and to cause air to vent from the air bladder.

In one example, the envelope is a superpressure envelope and the HAP further comprises a ballonet disposed within the envelope. In this case, the HAP may further comprise an altitude control system including an air intake and vent assembly operatively coupled to the ballonet and to the air bladder, wherein the control system is configured to actuate the altitude control system to cause ambient air to flow into either the ballonet or the air bladder and to cause air to vent from either the ballonet or the air bladder. The air intake and vent assembly may include a first subassembly operatively coupled to the ballonet and a second subassembly operatively coupled to the air bladder.

In another example, the control system is configured to create the thermal separation between the PV components and the envelope by at least partly inflating the air bladder.

In a further example, the air bladder comprises a set of air bladders that are configured for individual inflation and deflation. Here, the set of air bladders may include a main chamber disposed between the PV components and the first region of the envelope and a perimeter chamber extending at least partly around an edge of the main chamber. The perimeter chamber may be inflatable and deflatable to change an aerodynamic profile along at least one of a leading edge or a trailing edge of the main chamber. The perimeter chamber may include a series of individually adjustable chambers encircling the perimeter of the main chamber.

In yet another example, the control system is configured to cause the ambient air to flow into the air bladder or to cause the air to vent from the air bladder based on an operational condition of the HAP. Here, the operational condition may be a power generation condition. The operational condition may alternatively or additionally be at least one of a time of day, a season, an altitude, or a hemisphere of operation.

In another example, the HAP further comprises a lateral propulsion assembly, wherein the control system is configured to adjust an aerodynamic property of the HAP during lateral propulsion by inflating or deflating the air bladder. In a further example, the HAP also includes a payload including one or more communication modules configured to provide radio frequency or free space optical communication with another HAP, a satellite, or a ground-based device. Alternatively or additionally with any of the above configurations, the air bladder may be configured to provide structural support to the envelope during a lift gas fill process.

According to another aspect of the technology, a method of operating a lighter-than-air (LTA) high altitude platform (HAP) configured for operation in the stratosphere is provided. The method comprises identifying, by a control system of the HAP, a thermal condition of an envelope of the HAP, the envelope being configured to maintain pressurized lift gas therein; and causing, by the control system, either ambient air to flow into an air bladder of the HAP or air to vent from the air bladder based on the thermal condition to effect a thermal separation between one or more photovoltaic (PV) components and a first region of the envelope, wherein the air bladder is disposed between the one or more PV components and the first region of the envelope. In one example, the method further comprises the control system monitoring a power generation condition of the PV components.

In another example, causing the ambient air to flow into the air bladder includes actuating an air intake assembly of the HAP, and causing the air to vent from the air bladder includes actuating a vent assembly of the HAP.

In a further example, the air bladder comprises a set of air bladders, and the method further includes the control system causing one or more of the air bladders of the set to inflate or deflate to change an aerodynamic profile of the HAP.

And in yet another example, the method further comprises at least partly inflating the air bladder during a launch process to provide structural support to the envelope during a lift gas fill process.

### BRIEF DESCRIPTION OF THE DRAWINGS

FIG. 1 is a functional diagram of an example system in accordance with aspects of the disclosure.

FIGS. 2A-B illustrates lighter-than-air platform configurations in accordance with aspects of the disclosure.

FIGS. 3A-B illustrate example flight system modules including a payload, altitude control system and lateral propulsion system in accordance with aspects of the disclosure.

FIGS. 4A-C illustrate an example of a balloon platform in accordance with aspects of the disclosure.

FIGS. 5A-B illustrate an example shaped envelope platform in accordance with aspects of the disclosure.

FIGS. 6A-B illustrate photovoltaic components disposed along the envelope of a lighter-than-air platform in accordance with aspects of the technology.

FIG. 7 is a cross-sectional diagram showing an air bladder disposed between photovoltaic components and an envelope in accordance with aspects of the disclosure.

FIG. 8 is a top-down view showing an air bladder disposed on an envelope in accordance with aspects of the technology.

FIGS. 9A-E illustrate example air bladder configurations in accordance with aspects of the disclosure.

FIGS. 10A-B illustrate an example of using an air bladder to provide structural support to a shaped envelope during inflation at launch, in accordance with aspects of the technology.

FIG. 11 illustrates an example method of operation in accordance with aspects of the disclosure.

### DETAILED DESCRIPTION

### Overview

The technology relates to LTA high altitude platforms configured to operate in the stratosphere. Such platforms generate solar power from PV components such as solar panels or other PV cell configurations. While solar panels can be affixed to or part of the payload of the HAP, for larger dirigible-type LTAs having shaped envelopes (e.g., blimps or other airship types with elongated envelopes), additional PV components can be mounted along an upper surface region of the envelope. By way of example, the PV cell may include N-type material and P-type material sandwiched between electrodes (contacts). An anti-reflective coating may overlay the side of the PV cell that is arranged to face the sun. Other components may include a cover glass, focusing lens, diffraction grating, etc. The PV cell is configured to generate an electric current from the received light.

Stratospheric HAPs, such as LTA platforms, may have a float altitude of between about 50,000-120,000 feet above sea level. The ambient temperature may be on the order of −10° C. to −90° C. or colder, depending on the altitude and weather conditions. These and other environmental factors in the stratosphere can be challenging for HAP operation, especially for long-duration deployment for months or longer. The architectures discussed herein are designed to effectively operate in such conditions, although they may also be used in other environments with different types of systems besides LTA-type platforms.

As explained below, an example HAP may include one or both of altitude control and/or a lateral propulsion system. Altitude control may be employed using an active altitude control system (ACS), such as with a pump and valve-type assembly coupled with an onboard ballonet. The lateral propulsion system may employ a propeller assembly to provide directional adjustments to the HAP, for instance to counteract movement due to the wind, or to otherwise cause the HAP to move along a selected heading. Such altitude and lateral adjustments can enhance operation across a fleet of HAPs. For instance, by employing a small amount of lateral propulsion and/or vertical adjustment at particular times, a given platform may stay on station over a desired service area for a longer period, or change direction to move towards a particular place of interest. The platform may also be able to return to the desired service area more quickly using lateral propulsion and/or altitude adjustments to compensate against undesired wind effects. Applying this approach for some or all of the platforms in the fleet may mean that the total number of platforms required to provide a given level of service (e.g., telecommunications coverage for a service area) may be significantly reduced as compared to a fleet that does not employ lateral propulsion.

The ACS may include a pump and valve arrangement as part of a vent and air intake assembly for a ballonet, which may be received within the balloon envelope. One or more motors can be used to actuate a lateral propulsion system of the HAP to affect the directional changes. This can include a pointing axis motor for rotating the lateral propulsion system to a particular heading, and a drive motor for causing a propeller assembly or other propulsion mechanism to turn on and off. Powering the ACS, lateral propulsion system, communication system(s) and/or other modules of the HAP is done via an onboard power supply, such as one or more batteries that may be part of the payload assembly. The batteries may be charged using a solar power generation module, which includes solar panels or other PV components on the payload and/or the LTA envelope.

Adding solar power generation components along the top of the shaped envelope may cause a thermal challenge by increasing the internal temperature of the envelope under certain conditions. The solar components may also create an aerodynamic problem, which could impact lateral propulsion and/or elevational changes using the ACS. In addition, higher pressure ratios of shaped envelope configurations can add complexity to the ACS. To address these and other potential issues, an external air bladder assembly is disposed between the PV components and the shaped envelope, as discussed in detail below.

### Example Balloon Systems

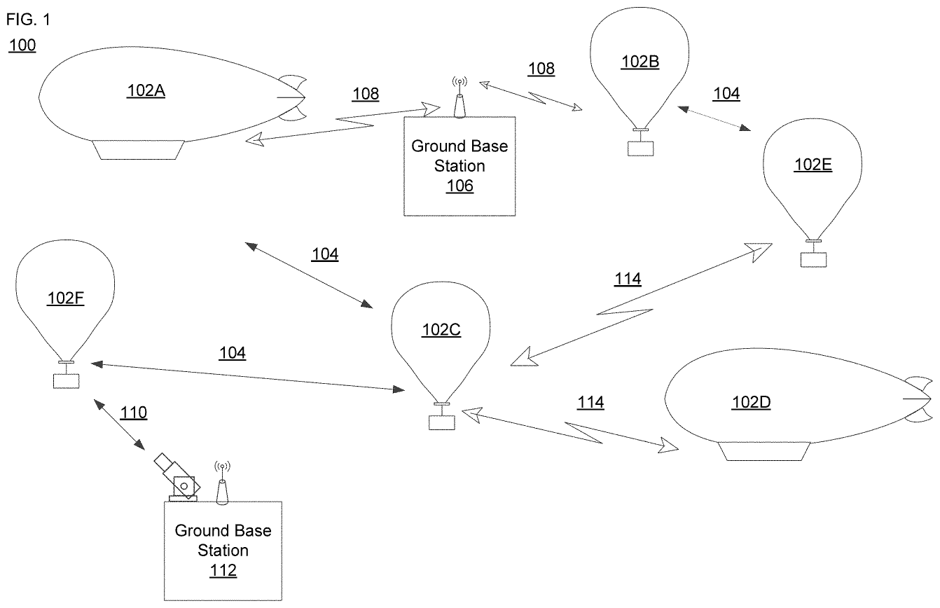

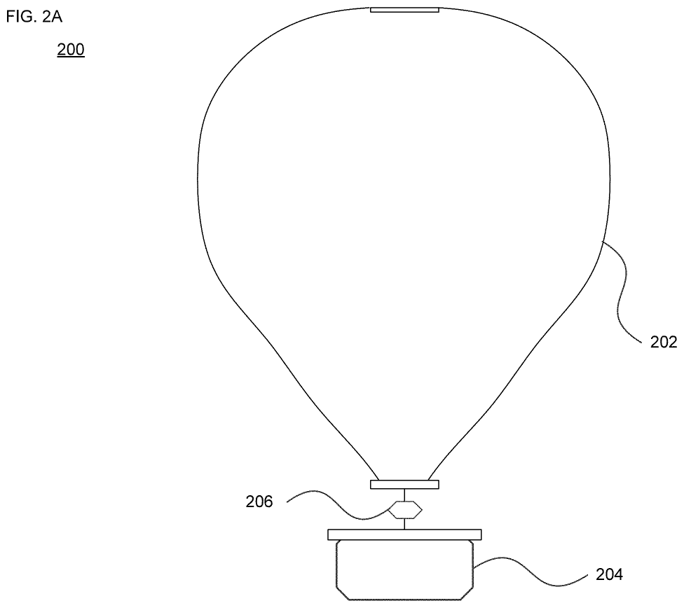

FIG. 1 depicts an example system 100 in which a fleet of high altitude platforms, such as LTA platforms, may be used. This example should not be considered as limiting the scope of the disclosure or usefulness of the features described herein. System 100 may be considered an LTA-based network. In this example, network 100 includes a plurality of devices, such as balloons or dirigibles 102A-F as well as ground-base stations 106 and 112. System 100 may also include a plurality of additional devices, such as various computing devices (not shown) as discussed in more detail below or other systems that may participate in the network.

The devices in system 100 are configured to communicate with one another. As an example, the HAPs may include communication links 104 and/or 114 in order to facilitate intra-balloon communications. Byway of example, links 114 may employ radio frequency (RF) signals (e.g., millimeter wave transmissions) while links 104 employ free-space optical transmission. Alternatively, all links may be RF, optical, or a hybrid that employs both RF and optical transmission. In this way balloons 102A-F may collectively function as a mesh network for data communications. At least some of the HAPs may be configured for communications with ground-based stations 106 and 112 via respective links 108 and 110, which may be RF and/or optical links.

In one scenario, a given HAP 102 may be configured to transmit an optical signal via an optical link 104. Here, the given HAP 102 may use one or more high-power light-emitting diodes (LEDs) to transmit an optical signal. Alternatively, some or all of the HAP 102 may include laser systems for free-space optical communications over the optical links 104. Other types of free-space communication are possible. Further, in order to receive an optical signal from another HAP via an optical link 104, the HAP may include one or more optical receivers.

The HAPs may also utilize one or more of various RF air-interface protocols for communication with ground-based stations via respective communication links. For instance, some or all of the HAPs 102A-F may be configured to communicate with ground-based stations 106 and 112 via RF links 108 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

In some examples, the links may not provide a desired link capacity for HAP-to-ground communications. For instance, increased capacity may be desirable to provide backhaul links from a ground-based gateway. Accordingly, an example network may also include downlink HAPs, which could provide a high-capacity air-ground link between the various HAPs of the network and the ground-base stations. For example, in network 100, dirigible 102A or balloon 102B operating in the stratosphere may be configured as a downlink HAP that directly communicates with station 106.

Like other HAPs in network 100, downlink HAP 102F may be operable for communication (e.g., RF or optical) with one or more other HAPs via link(s) 104. Downlink HAP 102F may also be configured for free-space optical communication with ground-based station 112 via an optical link 110. Optical link 110 may therefore serve as a high-capacity link (as compared to an RF link 108) between the network 100 and the ground-based station 112. Downlink HAP 102F may additionally be operable for RF communication with ground-based stations 106. In other cases, downlink HAP 102F may only use an optical link for balloon-to-ground communications. Further, while the arrangement shown in FIG. 1 includes just one downlink HAP 102F, an example balloon network can also include multiple downlink HAPs. On the other hand, a HAP network can also be implemented without any downlink HAPs.

A downlink HAP may be equipped with a specialized, high bandwidth RF communication system for balloon-to-ground communications, instead of, or in addition to, a free-space optical communication system. The high bandwidth RF communication system may take the form of an ultra-wideband system, which may provide an RF link with substantially the same capacity as one of the optical links 104.

In a further example, some or all of HAPs 102A-F could be configured to establish a communication link with space-based satellites and/or other types of non-LTA craft (e.g., drones, airplanes, gliders, etc.) in addition to, or as an alternative to, a ground based communication link. In some embodiments, a stratospheric HAP may communicate with a satellite or other high altitude platform via an optical or RF link. However, other types of communication arrangements are possible.

As noted above, the HAPs 102A-F may collectively function as a mesh network. More specifically, since HAPs 102A-F may communicate with one another using free-space optical links, the HAPs may collectively function as a free-space optical mesh network. In a mesh-network configuration, each HAP may function as a node of the mesh network, which is operable to receive data directed to it and to route data to other HAPs. As such, data may be routed from a source HAP to a destination HAP by determining an appropriate sequence of links between the source HAP and the destination HAP.

The network topology may change as the HAPs move relative to one another and/or relative to the ground. Accordingly, the network 100 may apply a mesh protocol to update the state of the network as the topology of the network changes. For example, to address the mobility of the HAPs 102A to 102F, the balloon network 100 may employ and/or adapt various techniques that are employed in mobile ad hoc networks (MANETs). Other examples are possible as well.

Network 100 may also implement station-keeping functions using winds and altitude control and/or lateral propulsion to help provide a desired network topology, particularly for LTA platforms. For example, station-keeping may involve some or all of HAPs 102A-F maintaining and/or moving into a certain position relative to one or more other HAPs in the network (and possibly in a certain position relative to a ground-based station or service area). As part of this process, each HAP may implement station-keeping functions to determine its desired positioning within the desired topology, and if necessary, to determine how to move to and/or maintain the desired position. Alternatively, the platforms may be moved without regard to the position of their neighbors, for instance to enhance or otherwise adjust communication coverage at a particular geographic location.

The desired topology may thus vary depending upon the particular implementation and whether or not the HAPs are continuously moving. In some cases, HAPs may implement station-keeping to provide a substantially uniform topology where the HAPs function to position themselves at substantially the same distance (or within a certain range of distances) from adjacent balloons in the network 100. Alternatively, the network 100 may have a non-uniform topology where HAPs are distributed more or less densely in certain areas, for various reasons. As an example, to help meet the higher bandwidth demands, HAPs may be clustered more densely over areas with greater demand (such as urban areas) and less densely over areas with lesser demand (such as over large bodies of water). In addition, the topology of an example HAP network may be adaptable allowing HAPs to adjust their respective positioning in accordance with a change in the desired topology of the network.

The HAPs of FIG. 1 may be platforms that are deployed in the stratosphere. As an example, in a high altitude network, the LTA platforms may generally be configured to operate at stratospheric altitudes, e.g., between 50,000 ft and 70,000 ft or more or less, in order to limit the HAPs' exposure to high winds and interference with commercial airplane flights. In order for the HAPs to provide a reliable mesh network in the stratosphere, where winds may affect the locations of the various HAPs in an asymmetrical manner, the HAPs may be configured to move latitudinally and/or longitudinally by adjusting their respective altitudes, such that the wind carries the respective HAPs to the respectively desired locations. This may be done using an ACS. Lateral propulsion may also be employed, e.g., via one or more propellers, to affect the HAP's path of travel.

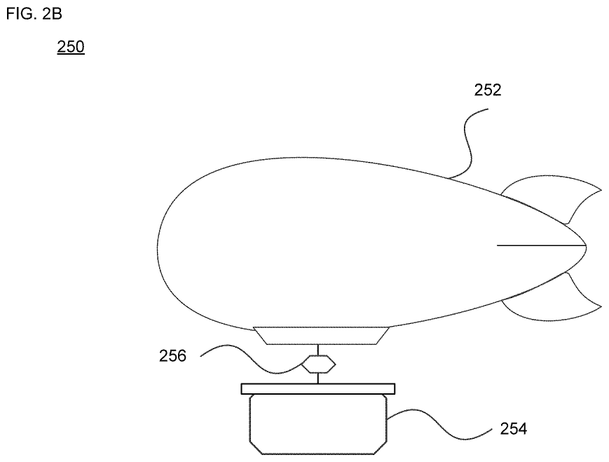

In an example configuration, the HAPs include an envelope and a payload, along with various other components. FIG. 2A is an example of a high-altitude balloon 200, which may represent any of the balloons of FIG. 1. As shown, the example balloon 200 includes an envelope 202, a payload 204 and a termination (e.g., cut-down & parachute) device 206. FIG. 2B is an example of a high-altitude airship 250, which may represent any of the dirigibles of FIG. 1. As shown, the example airship 250 includes a shaped envelope 252, a payload 254 and a termination (e.g., cut-down & parachute) device 256.

The envelope 202 or 252 may take various shapes and forms. For instance, the envelope may be made of materials such as polyethylene, mylar, FEP, rubber, latex, fabrics or other thin film materials or composite laminates of those materials with fiber reinforcements embedded inside or outside. Other materials or combinations thereof or laminations may also be employed to deliver required strength, gas barrier, RF and thermal properties. Certain materials may be more suitable for smaller balloon-shaped envelopes, such as transparent or translucent thin films such as polyethylene or polyethylene terephthalate. However, larger shaped envelopes may employ one or more fabric layers, which may be less translucent.

Furthermore, the shape and size of the envelope may vary depending upon the particular implementation. Additionally, the envelope may be filled with different types of gases, such as air, helium and/or hydrogen. Other types of gases, and combinations thereof, are possible as well. In some examples, an outer envelope may be filled with lift gas(es), while an inner ballonet may be configured to have ambient air pumped into and out of it for altitude control. Other ballonet configurations are possible, for instance with the ballonet forming an outer envelope, while an inner envelope holds lift gas(es).

Envelope shapes for LTA platforms may include typical balloon shapes like spheres and “pumpkins” (e.g., 200 in FIG. 2A), or aerodynamic shapes that are at least partly symmetric (e.g., teardrop-shaped, such as 252 in FIG. 2B), provide shaped lift, or are changeable in shape. Lift may come from lift gasses (e.g., helium or hydrogen) with or without using a ballonet or altitude control system, electrostatic charging of conductive surfaces, aerodynamic lift (wing shapes), air moving devices (propellers, flapping wings, electrostatic propulsion, etc.) or any hybrid combination of lifting techniques.

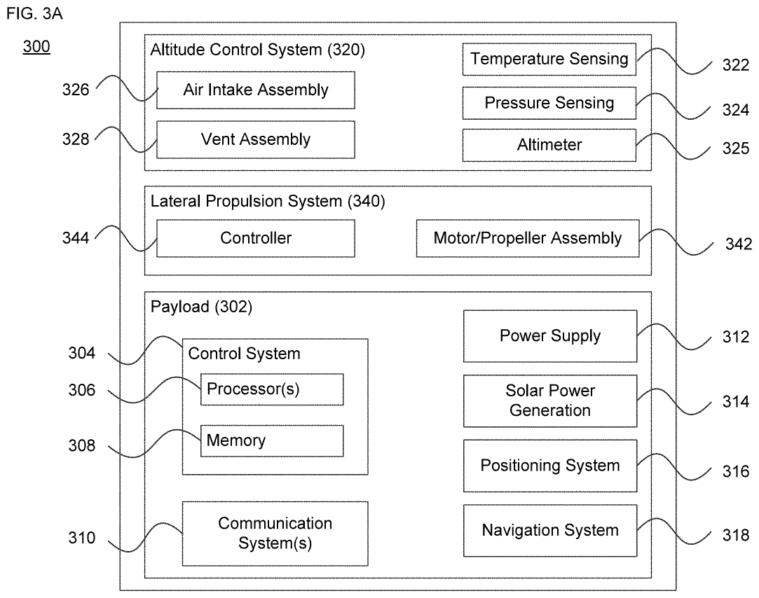

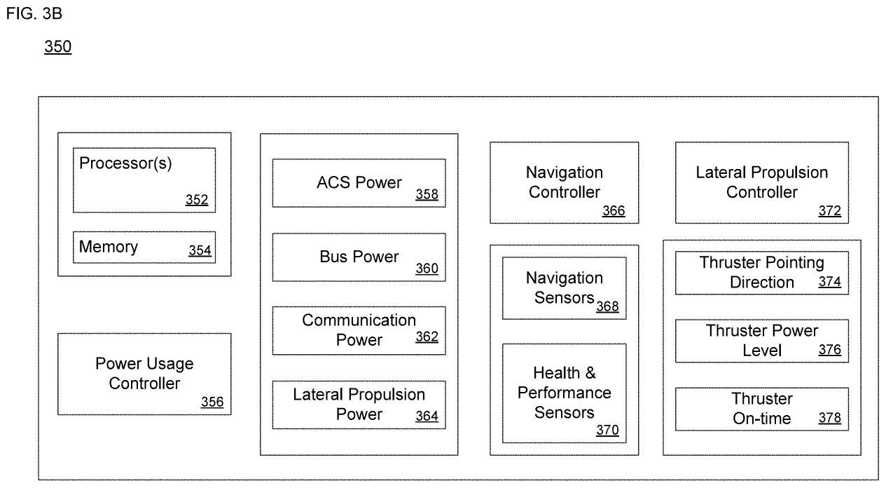

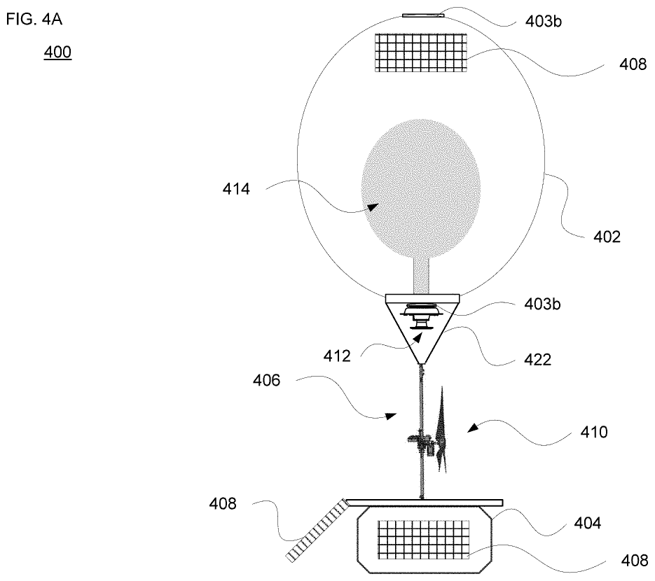

According to one example shown in FIG. 3A, a flight system 300 of the HAP includes a payload 302, an altitude control system 320, and a lateral propulsion system 340. The payload 302 includes a control system 304 having one or more processors 306 and on-board data storage in the form of memory 308. Memory 308 stores information accessible by the processor(s) 306, including instructions that can be executed by the processors. The memory 308 also includes data that can be retrieved, manipulated or stored by the processor. The memory can be of any non-transitory type capable of storing information accessible by the processor, such as a hard-drive, memory card, ROM, RAM, and other memories. The instructions can be any set of instructions to be executed directly, such as machine code, or indirectly, such as scripts, by the processor. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance.

The data can be retrieved, stored or modified by the one or more processors 306 in accordance with the instructions. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 306 can include any conventional processors, such as a commercially available CPU. Alternatively, each processor can be a dedicated component such as an ASIC, controller, or other hardware-based processor. Although FIG. 3A functionally illustrates the processor(s) 306, memory 308, and other elements of control system 304 as being within the same block, the system can actually comprise multiple processors, computers, computing devices, and/or memories that may or may not be stored within the same physical housing. For example, the memory can be a hard drive or other storage media located in a housing different from that of control system 304. Accordingly, references to a processor, computer, computing device, or memory will be understood to include references to a collection of processors, computers, computing devices, or memories that may or may not operate in parallel.

The payload 302 may also include various other types of equipment and systems to provide a number of different functions. For example, as shown the payload 302 includes one or more communication systems 310, which may transmit signals via RF and/or optical links as discussed above. The communication system(s) 310 include communication components such as one or more transmitters and receivers (or transceivers), one or more antennae, and a baseband processing subsystem. (not shown). In one scenario, a given communication module of the communication system operates in a directional manner. For instance, one or more high gain directional antennas may be mechanically or functionally pointed (e.g., via beamforming) in a selected direction(s) to enable uplink and/or downlink connectivity with other communications devices (e.g., other LTA platforms, ground stations, satellites in orbit or personal communication devices). In this case, it may be particularly beneficial to ensure that the given communication module is pointed at a target heading to ensure the communication link(s) (e.g., according to a determined communication bit error rate, signal-to-noise ratio, etc.).

The payload 302 is illustrated as also including a power supply 312 to supply power to the various components of the balloon. The power supply 312 could include one or more rechargeable batteries or other energy storage systems like capacitors or regenerative fuel cells. In addition, the payload 302 may include a power generation system 312 in addition to or as part of the power supply. The power generation system 314 may include solar panels or other PV components, stored energy (e.g., hot air relative to ambient air), relative wind power generation, or differential atmospheric charging (not shown), or any combination thereof, and could be used to generate power that charges and/or is distributed by the power supply 312. In some configurations, some of the PV components may be disposed along the payload while other PV components may be disposed along the envelope. In other configurations, the PV components may only be disposed along the envelope.

The payload 300 may additionally include a positioning system 316. The positioning system 316 could include, for example, a global positioning system (GPS) such as differential GPS (D-GPS), an inertial navigation system, and/or a star-tracking system. The positioning system 316 may additionally or alternatively include various motion sensors (e.g., accelerometers, magnetometers, gyroscopes, and/or compasses). The positioning system 316 may additionally or alternatively include one or more video and/or still cameras, and/or various sensors for capturing environmental data. Some or all of the components and systems within payload 302 may be implemented in a radiosonde or other probe, which may be operable to measure, e.g., pressure, altitude, geographical position (latitude and longitude), temperature, relative humidity, and/or wind speed and/or wind direction, among other information. Wind sensors may include different types of components like pitot tubes, hot wire or ultrasonic anemometers or similar, windmill or other aerodynamic pressure sensors, laser/lidar, or other methods of measuring relative velocities or distant winds.

Payload 302 may include a navigation system 318 separate from, or partially or fully incorporated into control system 304. The navigation system 318 may implement station-keeping functions to maintain position within and/or move to a position in accordance with a desired topology or other service requirement. In particular, the navigation system 318 may use wind data (e.g., from onboard and/or remote sensors) to determine altitudinal and/or lateral positional adjustments that result in the wind carrying the balloon in a desired direction and/or to a desired location. Lateral positional adjustments may also be handled directly by a lateral positioning system that is separate from the payload, which is discussed further below. Alternatively, the altitudinal and/or lateral adjustments may be computed by a central control location and transmitted by a ground based, air based, or satellite based system and communicated to the HAP. In other embodiments, specific HAPs may be configured to compute altitudinal and/or lateral adjustments for other HAPs and transmit the adjustment commands to those other HAPs. In some examples, part or all of the navigation system may be implemented by the lateral propulsion system 340.

As illustrated in FIG. 3A, the flight system 300 also includes altitude control system (ACS) 320 configured to carry out certain elevational positioning adjustments. The ACS may include sensors for temperature sensing 322 and/or pressure sensing 324, as well as an altimeter 325 to determine the HAP's altitude. It may also include an air intake assembly 326 and a vent assembly 328, for instance to respectively increase and decrease the amount of air within the ballonet. In one example, the air intake assembly may include a compressor or impeller to bring ambient air into the ballonet, and the vent assembly may include one or more valves to release the air from the ballonet to the external environment. While shown separately in this block diagram, the air intake and vent assemblies may be integrated as one unit.

In order to affect lateral positions or velocities, the platform includes lateral propulsion system 340. As shown in FIG. 3A, the lateral propulsion system 340 may include a motor and propeller assembly 342 and a controller 344. In this example, the motor is configured to turn or spin a propeller (or propellers) in order to increase or decrease the velocity of the aerial vehicle in a particular direction according to signals received from the controller 344. Changing the orientation of the propeller relative to the payload or other portions of the HAP may change the orientation and/or heading of HAP, similar to a rudder of a ship. In this regard, as compared to a typical balloon which does not utilize a propeller and simply relies on changes in ballast to move up and down and air currents to move in other directions, the LTA platform may have better steering control.

A block diagram of an exemplary electronics module 350 is illustrated in FIG. 3B. The electronics module may be part of or separate from the navigation system 318 or the control system 304 of the payload 302. As shown, a CPU, controller or other types of processor(s) 352, as well as memory 354, may be employed within the electronics module 350 to manage aspects of the lateral propulsion system. The operation of a despin mechanism may also be controlled by the processor(s) 352. A power usage controller 356 may be employed to manage various power subsystems of the electronics module, including for altitude control system (ACS) power 358 (e.g., to control buoyancy of the envelope/vertical positioning of the LTA platform), bus power 360, communication power 362 and lateral propulsion power 364. The power usage controller 356 may be separate from or part of the processor(s) 352.

The control subsystem may include a navigation controller 366 that is configured to employ data obtained from onboard navigation sensors 368, including an inertial measurement unit (IMU) and/or differential GPS, received data (e.g., weather information), and/or other sensors such as health and performance sensors 370 (e.g., a force torque sensor) to manage operation of the LTA vehicle's systems. The navigation controller 366 may be separate from or part of the processor(s) 352, and may operate independently or in conjunction with navigation system 318. The navigation controller 366 works with system software, ground controller commands, and health & safety objectives of the system (e.g., battery power, temperature management, electrical activity, etc.) and helps decide courses of action. The decisions based on the sensors and software may be to save power, improve system safety (e.g., increase heater power to avoid systems from getting too cold during stratospheric operation) or divert power to altitude control or divert power to lateral propulsion.

When decisions are made to activate the lateral propulsion system, the navigation controller then leverages sensors for position, wind direction, altitude and power availability to properly point the propeller and to provide a specific thrust condition for a specific duration or until a specific condition is reached (a specific velocity or position is reached, while monitoring and reporting overall system health, temperature, vibration, and other performance parameters). In this way, the navigation controller can continually optimize the use of the lateral propulsion systems for performance, safety and system health. Upon termination of a flight, the navigation controller can engage the safety systems (for example the propeller braking mechanism) to prepare the system to descend, land, and be recovered safely. Similarly, the ACS may be controlled to start or increase airflow into a ballonet or to pump air out from the ballonet. This can include actuating a compressor, pump, impeller or other mechanism to effect the desired amount of airflow or otherwise adjust the vertical position of the HAP in the stratosphere.

Lateral propulsion controller 372 is configured to continuously control the propeller's pointing direction (e.g., via a worm gear mechanism), manage speed of rotation, power levels, and determine when to turn on the propeller or off, and for how long. The lateral propulsion controller 372 thus oversees thruster pointing direction 374, thruster power level 376 and thruster on-time 378 modules. The lateral propulsion controller 372 may be separate from or part of the processor(s) 352. Processor software or received human controller decisions may set priorities on what power is available for lateral propulsion functions (e.g., using lateral propulsion power 364). The navigation controller then decides how much of that power to apply to the lateral propulsion motors and when (e.g., using thruster power level 376). In this way, power optimizations occur at the overall system level as well as at the lateral propulsion subsystem level. This optimization may occur in a datacenter on the ground or locally onboard the balloon platform.

The lateral propulsion controller 372 is able to control the drive motor of the propeller motor assembly so that the propeller assembly may operate in different modes. Two example operational modes are: constant power control or constant rotational velocity control. The electronics module may store data for both modes and the processor(s) of the control assembly may manage operation of the drive motor in accordance with such data. For instance, the processor(s) may use the stored data to calculate or control the amount of power or the rotational propeller velocity needed to achieve a given lateral speed. The electronics module may store data for the operational modes and the processor(s) of the control assembly may manage operation of the drive motor in accordance with such data. For instance, the processor(s) may use the stored data to calculate the amount of current needed to achieve a given lateral speed. The processor(s) may also correlate the amount of torque required to yield a particular speed in view of the altitude of the balloon platform. The processor(s) may control the drive motor continuously for a certain period of time, or may cycle the drive motor on and off for selected periods of time. This latter approach may be done for thermal regulation of the drive motor. For instance, the propeller may be actuated for anywhere from 1 second to 5 minutes (or more), and then turned off to allow for motor cooling. This may be dependent on the thermal mass available to dissipate heat from the motor.

All of the components of the electronics module 350 and the overall flight system 300 may be powered by power supply 312, which is operatively coupled to the solar power generation module 314.

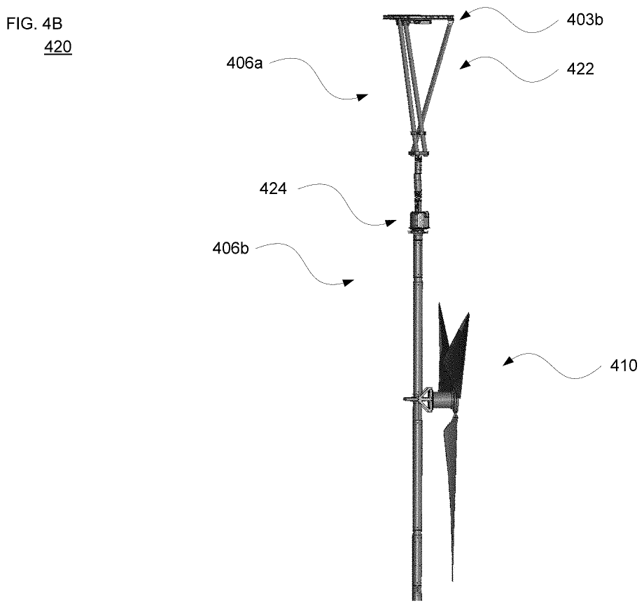

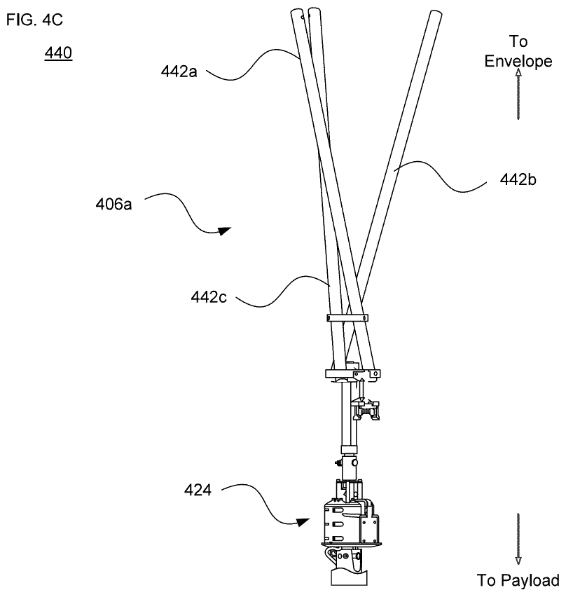

FIG. 4A illustrates one example configuration 400 of a balloon-type HAP with propeller-based lateral propulsion, as well as an exemplary ACS, which may be employed with any of the LTA platforms of FIG. 1. As shown, the example 400 includes an envelope 402 with a top cap 403a and a base cap 403b, a payload 404 and a down connect member 406 configured to couple the envelope 402 (e.g., via spars 422 connected to base cap 403b) and the payload 404 together. Cables or other wiring between the payload 404 and the envelope 402 may be run within or along the down connect member 406. One or more solar panel assemblies 408 may be coupled to the payload 404 or another part of the balloon platform, such as along an upper section of the envelope 402. The payload 404 and the solar panel assemblies 408 may be configured to rotate about the down connect member 406 (e.g., up to 360° rotation or more), for instance to align the solar panel assemblies 408 with the sun to maximize power generation. The envelope 402 may rotate freely with respect to the payload 404.

Example 400 illustrates a lateral propulsion system 410 using, for instance, one or more propeller assemblies. While this example of the lateral propulsion system 410 is one possibility, the location could also be fore and/or aft of the payload section 404, or fore and/or aft of the envelope section 402, or any other location that provides the desired thrust vector. Details of the lateral propulsion system 410 are discussed below. This example also includes an ACS 412, which is coupled to an interior ballonet 414 disposed within the envelope 402. The ACS 412 is configured to draw ambient air into the ballonet 414 and to expel air therefrom.

FIG. 4B illustrates a view 420 showing down-connect member 406 and lateral propulsion system 410. As shown in view 420 of FIG. 4B and the enlarged view 440 of FIG. 4C, upper portion 406a of the down connect member 406 may include a set of spars 422 coupled to the base cap 403b. The set of spars 422 may have a tripod configuration 442a-442c as illustrated in FIG. 4C. Disposed along portion 406b of the down connect member is a despin mechanism 424, which is configured to adjust for the relative rotations of the envelope and the payload by torqueing (e.g., rotating) the payload against the envelope. In this example, despin mechanism 424 is disposed above the lateral propulsion system (i.e., between the lateral propulsion system and the base cap of the envelope). In other configurations the despin mechanism 424 may be disposed below the lateral propulsion system (i.e., between the lateral propulsion system and the payload). The despin mechanism 424 may be controlled by a processor 306 of control system 304. In one example, one or more communication systems 310 or sensing systems on the payload may be directional or require a rotationally stable platform. In these situations, the despin system can be employed to achieve the necessary directional control or stabilization.

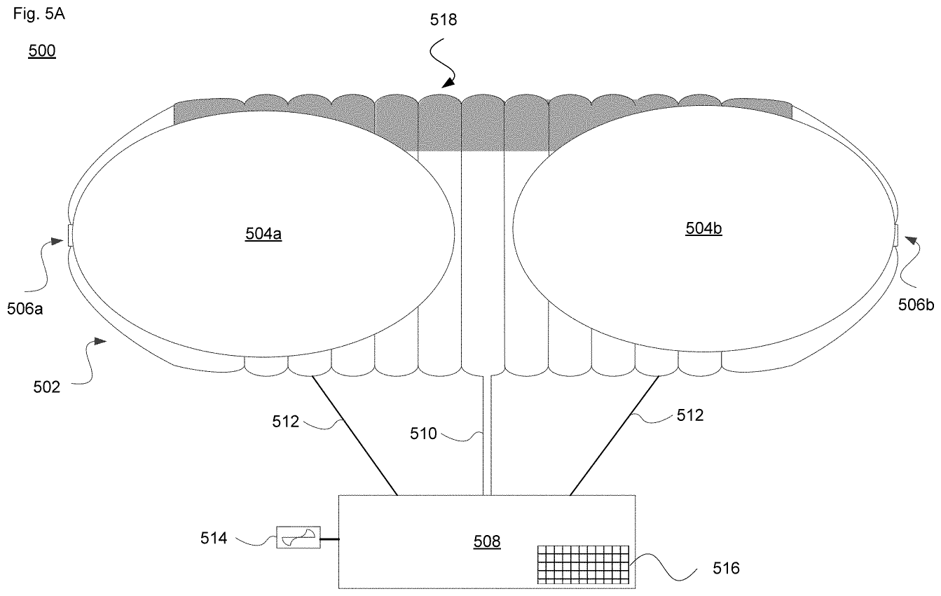

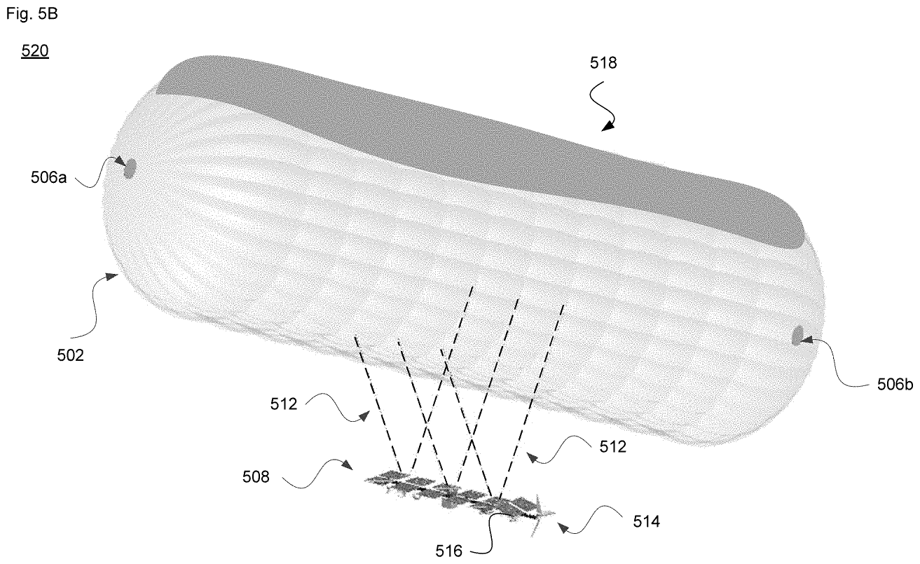

FIG. 5A illustrates an example configuration 500 of a shaped envelope-type HAP with propeller-based lateral propulsion and altitude control using internal ballonets. As shown in the partial see-through view of FIG. 5A, a pressurized envelope 502 has a pair of ballonets 504a and 504b received therein. In this example, ballonet 504a is arranged closer to end plate 506a which may be a forward end plate, and ballonet 504b is arranged closer to end plate 506b which may be a rearward end plate. Although not shown, additional ballonets may be arranged between and/or adjacent to ballonets 504a,b. Using multiple ballonets in such physical arrangements may provide stability and reduce the likelihood of the envelope 502 from becoming pitched (upward or downward relative to the ground surface) too far in a particular direction.

Also shown in FIG. 5A is a payload module 508, which may be coupled to the envelope 502 via a downconnect element 510, as well as one or more spars or cables 512. In this example, one or more propellers 514 of the lateral propulsion system may be connected to the payload module 508, although propellers may alternatively or additionally be connected to the downconnect element 510 and/or the envelope 502. Each of the one or more ballonets 504 may be connected to its own ACS module (not shown), for individualized inflation or deflation using separate air intake assemblies and vent assemblies.

Similar to the balloon-type HAP of example 400, in the example configuration 500 the payload 508 may have one or more solar panels 516 disposed therealong. As shown in FIG. 5A and in the perspective view of example 520 of FIG. 5B, additional or alternative PV components 518 are disposed on an upper region of the pressurized envelope 502. As the upper region of the envelop 502 will have direct exposure to the sun in many situations, it can be particularly beneficial to have PV components 518 arranged thereon. These components may be solar panels or layers of PV material.

### Example Arrangements

Employing larger and more robust systems with shaped envelopes may necessitate additional solar collection to power the various onboard systems. This can be challenging with a fabric-based envelope as a reduced amount of translucency means the shading is significantly more pronounced relative to a generally transparent balloon envelope made of plastic film. Thus, solar panels on the payload may not receive an optimal amount of sunlight due to shading from the fabric envelope. Therefore, according to one aspect of the technology, solar panels or other PV components are arranged along the top region of the envelope. This provides significant area for solar power generation without the need for additional structure as well as better efficiency given the orientation of the panels with respect to the sun.

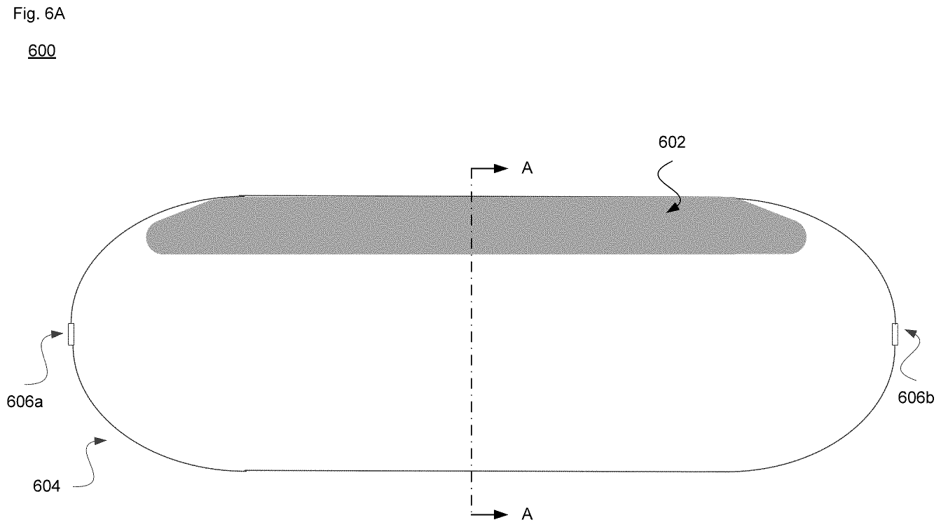

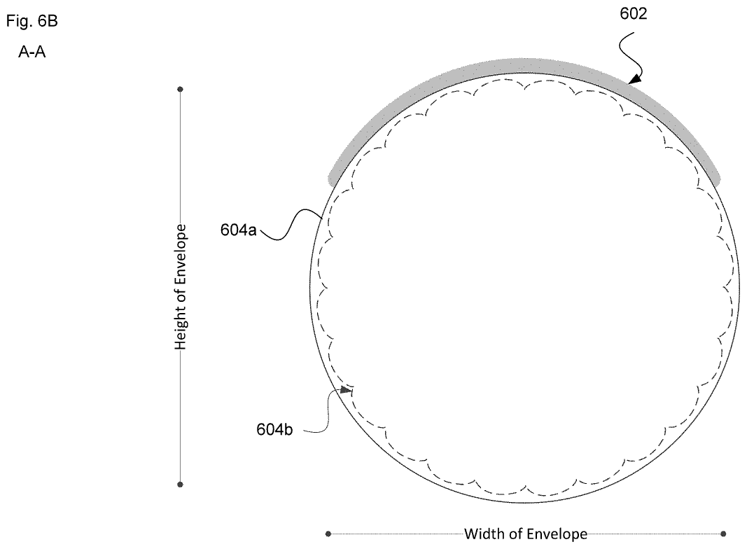

View 600 of FIG. 6A illustrates an example of PV material 602, such as an array of solar panels, arranged along the upper section of shaped envelope 604. As seen in this view, the envelope 604 is generally tubular in shape, tapering at either end to end plates 606a and 606b. FIG. 6B illustrates a cross-sectional view along the A-A line of FIG. 6A. As seen here, the PV material 602 lays over an outer skin or shell 604a of the envelope. The dashed portion 604b may represent an inner skin or a ballonet within the outer skin/shell.

One of the downsides to putting solar components on the envelope is that it increases the thermal load on the envelope material, which can reduce the effective strength of the material. For instance, as the PV material absorbs light from the sun, that material becomes hotter. Heating of the PV material can, in turn, cause the envelope material to increase in temperature, which may then cause the gas(es) within the envelope to increase in temperature. The PV material may act as a thermal blanket, preventing the envelope from cooling effectively. This, in turn, may reduce the factor of safety and subsequently the life of the vehicle. Another complication with mounting the panels on the envelope is the interruption of the smooth top surface, which can adversely impact the parasitic drag and therefore reduce the aerodynamic efficiency.

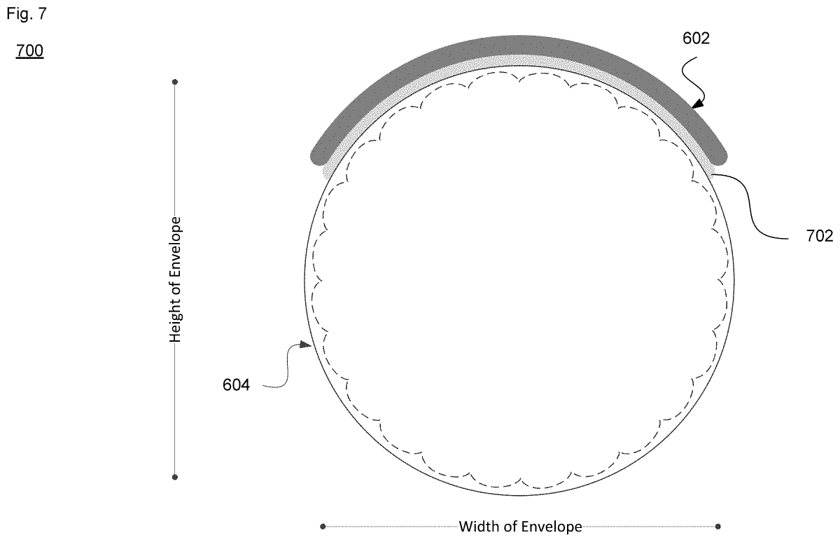

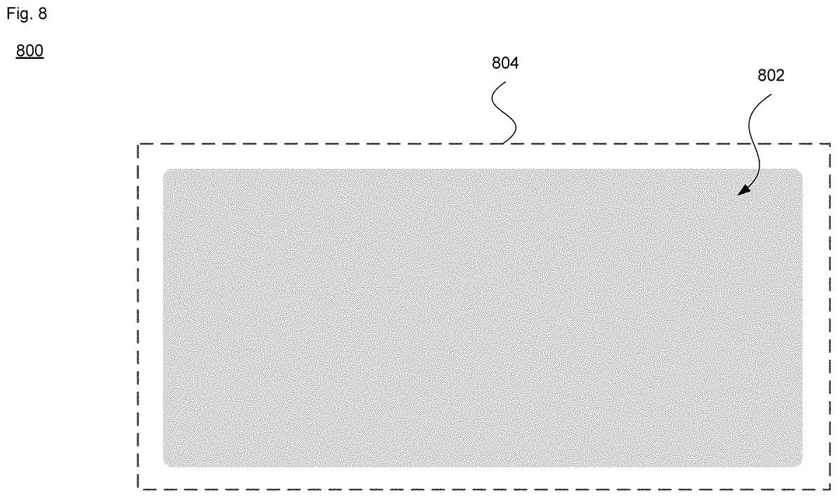

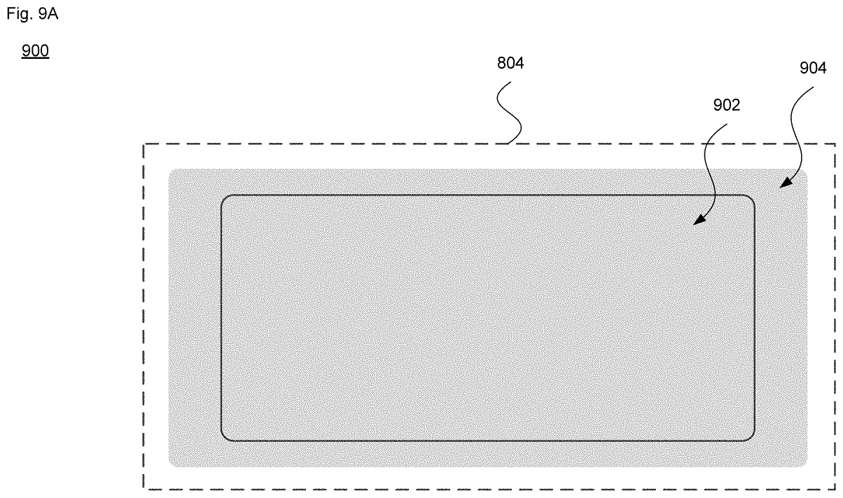

To mitigate these issues, an insulative layer is provided between the PV components and the envelope material. According to one aspect of the technology, the insulative layer comprises one or more air bladders disposed under the solar panels (or other PV components) and the outer shell of the envelope. FIG. 7 illustrates a cross-sectional view 700 in which an air bladder layer 702 is disposed between the PV material 602 and the envelope shell 604. FIG. 8 is a top-down view 800 showing an example of a rectangular air bladder 802 disposed on an upper section 804 of the envelope, which is illustrated in dashed lines. Adding an air bladder under the solar panels or other PV material is a way to help mitigate the thermal transfer from the solar panels to the envelope skin.

The air bladder can utilize different materials and/coatings to manage the material absorptivity and emissivity to maximize the thermal efficiency of the bladder. For instance, the emissivity and reflectivity of the bladder material can be selected to control its insulative properties. This can include using a metallized film or other materials having a selected index of refraction or reflection to achieve a maximum amount of insulation.

Similar to operation of the ballonet(s), the air bladder is coupled to an air intake and venting assembly for inflation and deflation as needed. In one example, this assembly may be directly connected to the air bladder. In another example, the assembly may be located remote from the air bladder, such as on the payload, and coupled to the air bladder via one or more conduits. In a further example, the assembly may be part of the ACS that is coupled to one or more of the ballonets of the envelope. A controller of the payload (e.g., processor 306 of control system 304), lateral propulsion system (e.g., controller 344 of system 340 or processor 352 of electronics module 350), or of the altitude control system itself (e.g., ACS 320) can be used to inflate and deflate the air bladder.

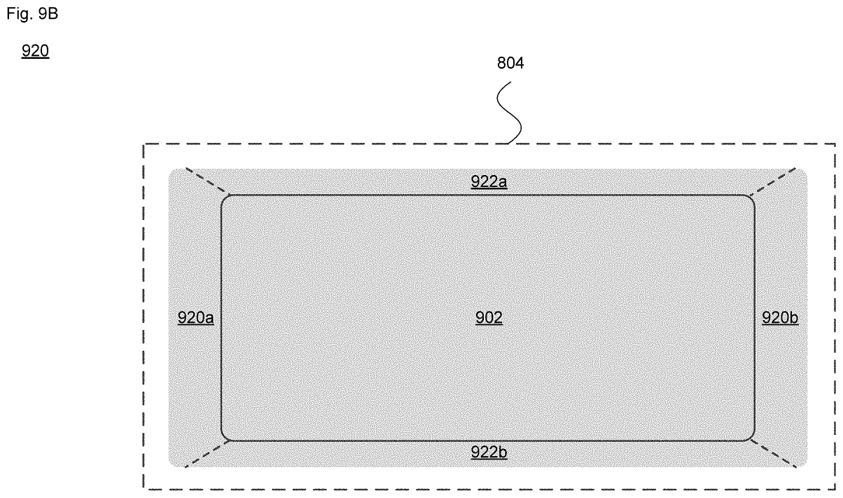

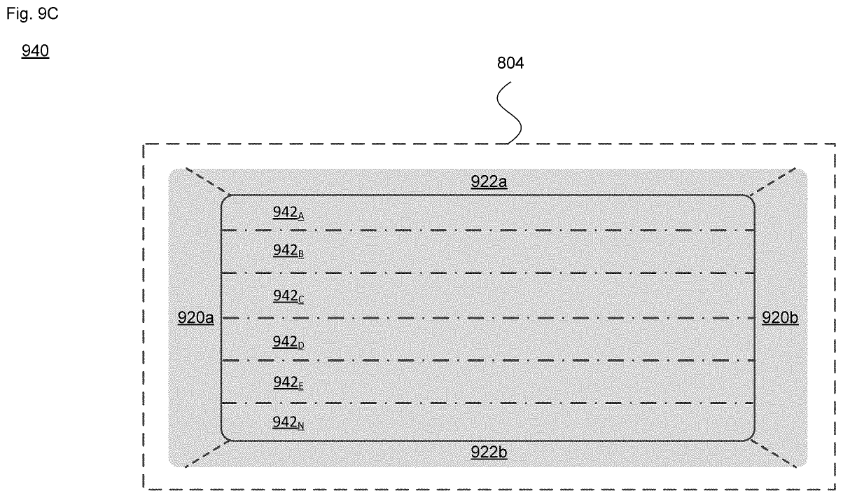

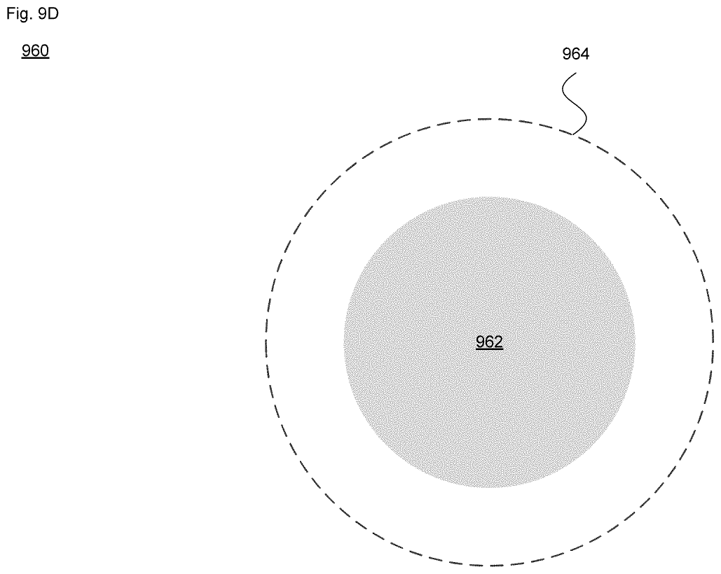

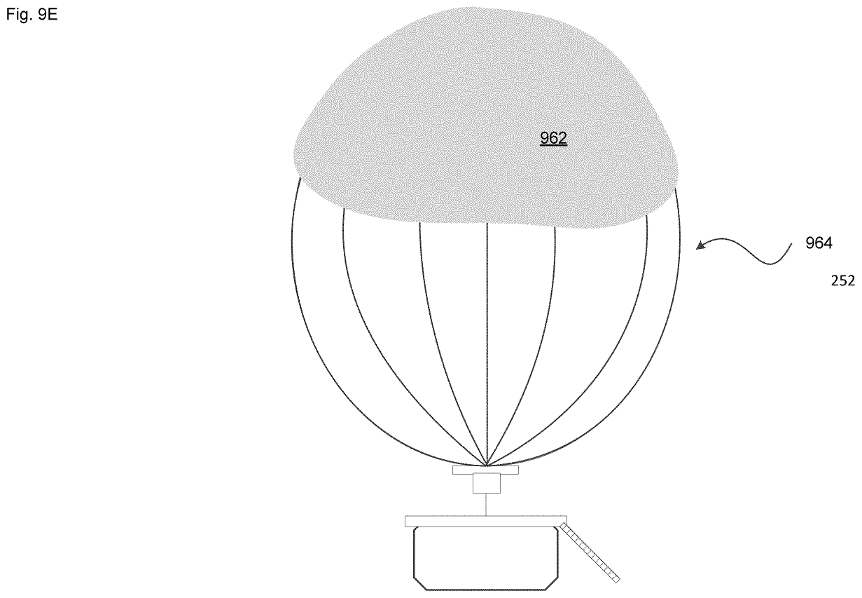

While one bladder is shown in FIG. 8, multiple air bladders may be employed. For instance, as illustrated in example 900 of FIG. 9A, the bladder can have an independent perimeter chamber 904 that surrounds a main chamber 902 disposed under the solar panels. This can create more aerodynamically efficient leading and trailing edges to better blend the envelope surface with the panel surface. In another example 920 shown in FIG. 9B, the perimeter chamber can comprise a set of chambers 920 and 922 surrounding the main chamber 902. Here, the leading and trailing edges may each have a chamber 920a and 920b, respectively, and the sides may have separate chambers 922a and 922b, respectively. This can be particularly beneficial when the envelope shape is not a simple cylinder (or generally circular when using a pumpkin-shaped balloon envelope).

In yet another configuration 940 shown in FIG. 9C, the main chamber shown in FIGS. 9A and 9B may be replaced by a set of chambers 942 (e.g., 942A-942N). This may be done to account for a non-uniform envelope shape and/or a non-uniform distribution of solar panels or other PV components along the envelope. As shown, the set of chambers 942 may be a series of longitudinal chambers extending between the leading and trailing edges. Alternatively, the chambers 942 may extend laterally between the left and right sides. In still other configurations, the chambers 942 (and/or chambers 920, 922 or even 902) may be of different shapes, such as square, circular, oval, trapezoidal, triangular, etc. The size, arrangement and overall bladder configuration can be selected to improve the HAP's aerodynamic profile as it moves through the stratosphere.

While the examples of FIGS. 9A-C are for shaped fabric envelopes suitable for use with large dirigibles that have, the bladder architectures discussed herein may also be employed with film-based materials such as transparent plastic films that may be used on pumpkin-type balloons. FIG. 9D illustrates a top-down view of another example 960, in which a bladder 962 is disposed on balloon envelope 964. FIG. 9E is a side view showing the bladder 962 on the pumpkin-shaped envelope 964.

Each of the air bladders may be individually operated, for instance via separate air intake and venting assemblies. In other configurations, one or more air intake and venting assemblies may be controlled by one or more processors of the HAP to inflate and deflate the various air bladders via separate conduits.

In one scenario, at night when the PV components are no longer generating waste heat (e.g., reradiated heat) and energy for lateral propulsion is more “expensive” the bladder(s) under the PV components can be deflated so that the panels are closer to the envelope and therefore create less drag on the envelope. This may also be done if the amount of heat generated drops below some threshold, for instance due to a low solar angle. By way of example only, the threshold may be between 25%-75% of an expected or estimated power generation goal, which may vary depending on time of day, season, HAP altitude, hemisphere of operation, etc. Deflating the bladder(s), which allows the PV component layer to have a minimum separation from the envelope, can reduce heat loss through the envelope, thereby aiding the envelope in retaining a higher internal temperature than the ambient air overnight, which can reduce the risk of entering a zero-pressure condition that can cause the vehicle to lose altitude and potentially require termination.

Another use for an external air bladder is to provide an additional ballast chamber that can be pressurized with respect to the ambient pressure in the external environment rather than the superpressure of the envelope. This can allow for a lower pressure ratio on the bladder's compressor, which improves its efficiency. For instance, as the pressure ratio increases beyond 1.5 (or more or less, such as +/−10% more or less), this can require a multi-stage compressor that is more complex than a single-stage compressor. For HAPs that use pressure supported control surfaces (e.g., tail fins) a similar effect can be achieved with the ballast chamber arrangement.

To significantly change the total mass of the HAP, large air volumes or extreme pressures may be required. However, when used in concert with the more traditional internal ballast chamber, the external chambers described herein can add some amount of additional mass at a lower pressure ratio. In this case, one approach would be to run the primary chamber (e.g., of the internal ballonet(s)) up to the maximum pressure ratio of a single stage compressor. At this point, a secondary compressor could then build super pressure in the external air bladder(s) to further increase the total system mass. This could be done to change the altitude, e.g., to elevate or descend the HAP to a different altitude to take advantage of a different wind pattern, to proactively or reactively pressurize the system in view of a lack of sunlight (e.g., after dusk), or to take some other corrective action.

Another benefit to employing the external air bladder architecture is to assist in the inflation and launch of large shaped envelopes. For instance, before launch, the envelope may be stored in a box or other pre-launch assembly, where the envelope is in a folded configuration. One or more fill ports are used to fill the main chamber of the envelope with lift gas. As lift gas is added, the envelope slowly takes shape. Due to air pressure at ground (or launch) level, the envelope may not be fully inflated at launch. In some situations, uninflated or underinflated portions of the envelope could snag on the HAP launch rig, which could have serious implications for the launch or for long-term operation of the HAP should the snag cause a tear in the plastic film or fabric of the envelope. One way to reduce the likelihood of this situation is to partially or fully inflate the air bladder(s) during launch, so that the bladders act as air pressure tubes or other structure, which can help the envelope achieve a desirable launch configuration. The pressure tubes can be adjusted after launch to help the envelope achieve its final shape during ascent.

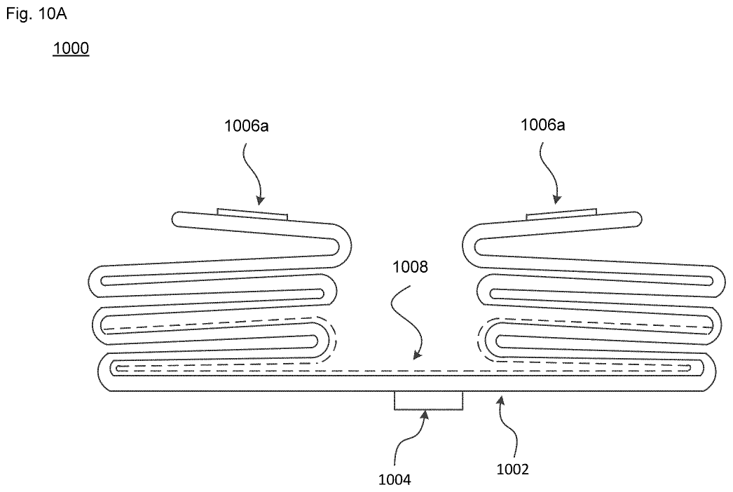

For example, FIG. 10A illustrates an example 1000 of a folded shaped envelope 1002 pre-inflation. In this example, a central fill port 1004 may be located at an apex ring located at the bottom of the fold stack. The fill port 1004 can be used to fill the envelope with lift gas. End plates 1006a and 1006b may be located at opposite ends of the fold stack, for instance to inflate and deflate one or more ballonets within the envelope (not shown). Dashed line 1008 indicates an air bladder (or bladders) that can be used to provide structural support to the envelope 1002 as it is inflated for launch and, as noted above, can be adjusted after launch to help the envelope achieve its final shape. FIG. 10B illustrates a view 1020 of the envelope 1002 as it is being inflated, with the air bladder used to provide structural support. As seen here, the envelope is not fully inflated, even though all of the lift gas may have been introduced. Full pressurization may occur once the HAP arrives in the stratosphere, such as shown in the example of FIG. 5B.

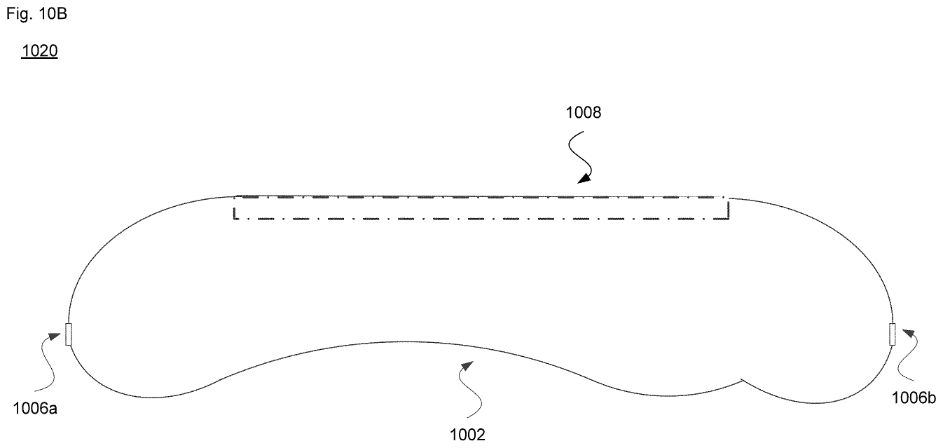

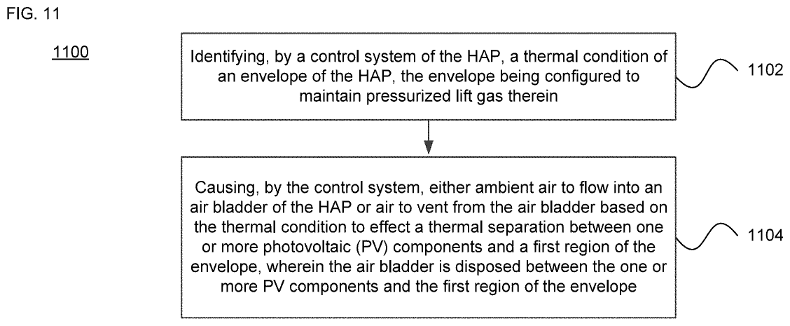

FIG. 11 illustrates a flow diagram 1100, which provides a method of operating a lighter-than-air HAP that is configured for operation in the stratosphere. The method comprises identifying at block 1102, by a control system of the HAP, a thermal condition of an envelope of the HAP, the envelope being configured to maintain pressurized lift gas therein. And at block 1104, the method includes causing, by the control system, either ambient air to flow into an air bladder of the HAP or air to vent from the air bladder based on the thermal condition to effect a thermal separation between one or more photovoltaic (PV) components and a first region of the envelope. The air bladder is disposed between the one or more PV components and the first region of the envelope. The method may further include further comprising the control system monitoring a power generation condition of the PV components.

The foregoing examples are not mutually exclusive and may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A lighter-than-air (LTA) high altitude platform (HAP) configured for operation in the stratosphere, comprising:
an envelope configured to maintain pressurized lift gas therein;
a solar power generation system including one or more photovoltaic (PV) components configured to convert light into electricity, the one or more PV components being disposed along a first region of the envelope arranged to face the sun when operating in the stratosphere;
an air bladder disposed between the one or more PV components and the first region of the envelope, the air bladder configured to provide thermal separation between the one or more PV components and the first region of the envelope; and
a control system configured to cause ambient air to flow into the air bladder and to cause air to vent from the air bladder.

2. The HAP of claim 1, wherein the envelope is a superpressure envelope and the HAP further comprises a ballonet disposed within the envelope.

3. The HAP of claim 2, further comprising an altitude control system including an air intake and vent assembly operatively coupled to the ballonet and to the air bladder, wherein the control system is configured to actuate the altitude control system to cause ambient air to flow into either the ballonet or the air bladder and to cause air to vent from either the ballonet or the air bladder.

4. The HAP of claim 3, wherein the air intake and vent assembly includes a first subassembly operatively coupled to the ballonet and a second subassembly operatively coupled to the air bladder.

5. The HAP of claim 1, wherein the control system is configured to create the thermal separation between the PV components and the envelope by at least partly inflating the air bladder.

6. The HAP of claim 1, wherein the air bladder comprises a set of air bladders that are configured for individual inflation and deflation.

7. The HAP of claim 6, wherein the set of air bladders includes a main chamber disposed between the PV components and the first region of the envelope and a perimeter chamber extending at least partly around an edge of the main chamber.

8. The HAP of claim 7, wherein the perimeter chamber is inflatable and deflatable to change an aerodynamic profile along at least one of a leading edge or a trailing edge of the main chamber.

9. The HAP of claim 7, wherein the perimeter chamber includes a series of individually adjustable chambers encircling the perimeter of the main chamber.

10. The HAP of claim 1, wherein the control system is configured to cause the ambient air to flow into the air bladder or to cause the air to vent from the air bladder based on an operational condition of the HAP.

11. The HAP of claim 10, wherein the operational condition is a power generation condition.

12. The HAP of claim 10, wherein the operational condition is at least one of a time of day, a season, an altitude, or a hemisphere of operation.

13. The HAP of claim 1, further comprising a lateral propulsion assembly, wherein the control system is configured to adjust an aerodynamic property of the HAP during lateral propulsion by inflating or deflating the air bladder.

14. The HAP of claim 1, further comprising a payload including one or more communication modules configured to provide radio frequency or free space optical communication with another HAP, a satellite, or a ground-based device.

15. The HAP of claim 1, wherein the air bladder is configured to provide structural support to the envelope during a lift gas fill process.

16. A method of operating a lighter-than-air (LTA) high altitude platform (HAP) configured for operation in the stratosphere, the method comprising:
identifying, by a control system of the HAP, a thermal condition of an envelope of the HAP, the envelope being configured to maintain pressurized lift gas therein; and
causing, by the control system, either ambient air to flow into an air bladder of the HAP or air to vent from the air bladder based on the thermal condition to effect a thermal separation between one or more photovoltaic (PV) components and a first region of the envelope, wherein the air bladder is disposed between the one or more PV components and the first region of the envelope.

17. The method of claim 16, further comprising the control system monitoring a power generation condition of the PV components.

18. The method of claim 16, wherein:
causing the ambient air to flow into the air bladder includes actuating an air intake assembly of the HAP; and
causing the air to vent from the air bladder includes actuating a vent assembly of the HAP.

19. The method of claim 16, wherein the air bladder comprises a set of air bladders, and the method further includes the control system causing one or more of the air bladders of the set to inflate or deflate to change an aerodynamic profile of the HAP.

20. The method of claim 16, further comprising at least partly inflating the air bladder during a launch process to provide structural support to the envelope during a lift gas fill process.
